(19) United States
(12) Patent Application Publication
(10) Pub. No.: US 2024/0230940 A9
(43) Pub. Date: Jul. 11, 2024

(54) UMBILICAL CABLE WITH SENSORS FOR COLLECTING SUBSURFACE DATA AND METHOD

(71) Applicant: CGG SERVICES SAS, Massy Cedex (FR)

(72) Inventor: Richard FLOWER, Katy, TX (US)

(21) Appl. No.: 17/969,182

(22) Filed: Oct. 19, 2022

(51) Int. Cl. G01V 1/38; G01V 1/133; G01V 1/18

(52) U.S. Cl. CPC G01V 1/3843; G01V 1/133; G01V 1/186; G01V 2210/121; G01V 2210/1293; G01V 2210/1423

(57) ABSTRACT

An umbilical-based marine acquisition system includes an umbilical cable configured to be attached with a proximal end to a vessel and to provide compressed air to a seismic source, a sensor loaded section having plural seismic sensors distributed along a length of the sensor loaded section, the sensor loaded section being configured to be attached with a distal end to another sensor loaded section or to the seismic source, and an umbilical-sensor section connection configured to connect a distal end of the umbilical cable to a proximal end of the sensor loaded section. The umbilical-sensor section connection and the sensor loaded section are configured to transmit seismic data acquired by the plural seismic sensors to the vessel.

### BACKGROUND

### Technical Field

Embodiments of the subject matter disclosed herein generally relate to collecting seismic data during a marine survey and, more particularly, to modifying/adapting/manufacturing an umbilical cable, which tows a source underwater, to collect seismic data with negative seismic offset by distributing plural sensors on the umbilical cable.

### Discussion of the Background

Developing offshore oil and gas production fields has found renewed interest in recent years. Due to the high cost of offshore drilling, those undertaking it rely heavily on marine seismic surveys and other geological investigations for surveying the subsurface before selecting drilling locations so as to minimize the risk of a dry well. In addition, the marine seismic surveys may be used for determining subfloor locations for carbon capture and sequestration (which may be linked to the oil and gas development operations), estimate potential of geothermal reserves, and/or identify/estimate the presence/absence of other subsurface resources as minerals. Marine surveys generate profiles (images) of the geophysical structure under the seafloor by acquiring seismic data with plural sensors towed with streamers or OBN above the subsurface of interest and then processing the seismic data to generate an image of the subsurface. While these profiles do not provide an accurate location of oil and gas reservoirs, those trained in the field may use them to estimate the presence or absence of oil and/or gas.

A marine seismic survey may be performed using the marine seismic survey system 100 illustrated in FIG. 1 (bird's-eye view). A vessel 110 tows through the water two seismic sources 120 and a streamer spread 130, which includes multiple seismic streamers 132. Each seismic source 120 typically includes plural sub-arrays 122 of air guns configured to generate seismic waves. The seismic waves propagate downward into the geophysical structure to be surveyed, under the seafloor, and are reflected upward from interfaces between geological layers. Hydrophones 134 (only two are shown for simplicity, but each streamer 132 may include hundreds of them) embedded in the seismic streamers detect the reflected waves. Data related to the reflected waves is recorded and processed to provide information about the underlying geological features.

Each sub-array 122 of the source 120 (a source typically has 2 or 3 sub-arrays) is connected to the vessel 110 by a corresponding umbilical cable 124. An umbilical cable is used in the industry to describe the cables that are used to tow the sub-arrays (also known as gun strings) through the water from a vessel. The gun strings contain arrays of seismic guns or chambers which when fired together, create an impulsive seismic signal which is used to image and map the subsurface. In addition to physically towing the gun strings, the umbilical cables also supply compressed air, electrical power and telemetry lines to the source chambers and other equipment mounted on the gun strings.

A typical marine seismic vessel will have up to 9 umbilical winches which will be in use for making up the source arrays. Dual sources are usually composed of 3-gun strings each, triple sources are composed of 2 or 3 gun strings each. Other arrangements of gun strings are also possible, such as the Penta source, where different combinations of gun arrays are fired when being towed at equal crossline distances.

The umbilical cables 124 are stored on large winches 126 (only one is shown in FIG. 1 for simplicity) within the seismic vessel 110, usually on the source handling deck, which is at the rear of the vessel and close to the water line. The electronics and compressed air conduit enter the umbilical lines through a slip ring arrangement in the center of the reel. The gun strings are deployed into the water using an overhead track or boom systems. Once the gun strings are in the water, the umbilical cable is under tension due to the resistance of the gun string being towed through the water and can be deployed or retrieved by rotating the umbilical winch.

For a typical 3D vessel towing 12 streamers, the gun strings are deployed at a distance L=500 m behind the vessel. In the case of 3D streamer vessels, once deployed, the gun strings 122 are either held in place via separation ropes 128, which are connected to the streamer leadins 136 by a corresponding connection rope 129, or they are provided with one or more steering devices (not shown) to maintain their crossline position (along Y direction) relative to each other. For source vessels where no streamers are used, the source arrays are typically towed 150 to 200 m behind the vessel. The crossline separations between the sub arrays 122 are maintained by small deflectors 138 often towed on one or both sides of the sources or by steering devices as part of the gun strings. Individual sub-arrays making up a source are typically towed between 8 to 10 m apart in the crossline direction. The crossline distance CL between the center of the full source arrays can range from 25 m to over 500 m for ultra-wide tow setups. In recent years, there has been a push to tow wider sources to limit the distance from the center of source to the outer streamer cables or achieve greater efficiencies.

With this arrangement, as illustrated in FIG. 1, the distance between the center of sources and the first receiver group 134 is called the seismic offset 140. The seismic offset 140 corresponds to an area for which no reflections from the subsurface are recorded, which creates a gap of missing near traces in this zone. These missing offsets are important as they will complement traditional towed streamer seismic data or externally recorded data such as OBN surveys. The addition of the near offsets improves imaging and also provides benefits for amplitude versus offset (AVO) analysis.

Accordingly, it would be desirable to provide mechanisms and methods that avoid the afore-described problems and drawbacks related to seismic data acquisition with marine survey systems.

### SUMMARY

According to an embodiment, there is an umbilical-based marine acquisition system that includes an umbilical cable configured to be attached with a proximal end to a vessel and to provide compressed air to a seismic source, a sensor loaded section having plural seismic sensors distributed along a length of the sensor loaded section, the sensor loaded section being configured to be attached with a distal end to another sensor loaded section or to the seismic source, and an umbilical-sensor section connection configured to connect a distal end of the umbilical cable to a proximal end of the sensor loaded section. The umbilical-sensor section connection and the sensor loaded section are configured to transmit seismic data acquired by the plural seismic sensors to the vessel.

According to another embodiment, there is an umbilical cable that includes a body configured to be attached with a proximal end to a vessel and with a distal end to a seismic source, and plural seismic sensors distributed along a length of the body. The is configured to transmit seismic data acquired by the plural seismic sensors to the vessel.

According to yet another embodiment, there is a total data acquisition system that includes a seismic source configured to be towed in water and to generate seismic waves with plural air guns, an umbilical cable configured to be attached with a proximal end to a vessel and to provide compressed air to the seismic source, a sensor loaded section having plural seismic sensors distributed along a length of the sensor loaded section, the sensor loaded section being configured to be attached with a distal end to another sensor loaded section or to the seismic source, an umbilical-sensor section connection configured to connect a distal end of the umbilical cable to a proximal end of the sensor loaded section, and plural streamers having plural seismic sensors. The umbilical-sensor section connection and the sensor loaded section are configured to pass the compressed air to the seismic source.

According to still another embodiment, there is a method for simultaneously collecting seismic data with positive and negative seismic offsets, the method including the steps of towing a seismic source in water, supplying with an umbilical cable, which is configured to be attached with a proximal end to a vessel, compressed air to the seismic source, firing the seismic source, based on the compressed air, to generate seismic waves, recording umbilical seismic data with a sensor loaded section having plural seismic sensors distributed along a length of the sensor loaded section, the sensor loaded section being configured to be attached with a distal end to another sensor loaded section or to the seismic source, and recording streamer seismic data with plural streamers having plural seismic sensors. The sensor loaded section is configured to pass the compressed air to the seismic source, and the umbilical seismic data and the streamer seismic data are simultaneously recorded, the umbilical seismic data has a negative seismic offset, and the streamer seismic data has a positive seismic offset.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a marine survey system in which a vessel tows seismic sources with umbilical cables and records seismic data with sensors located exclusively on the streamers;

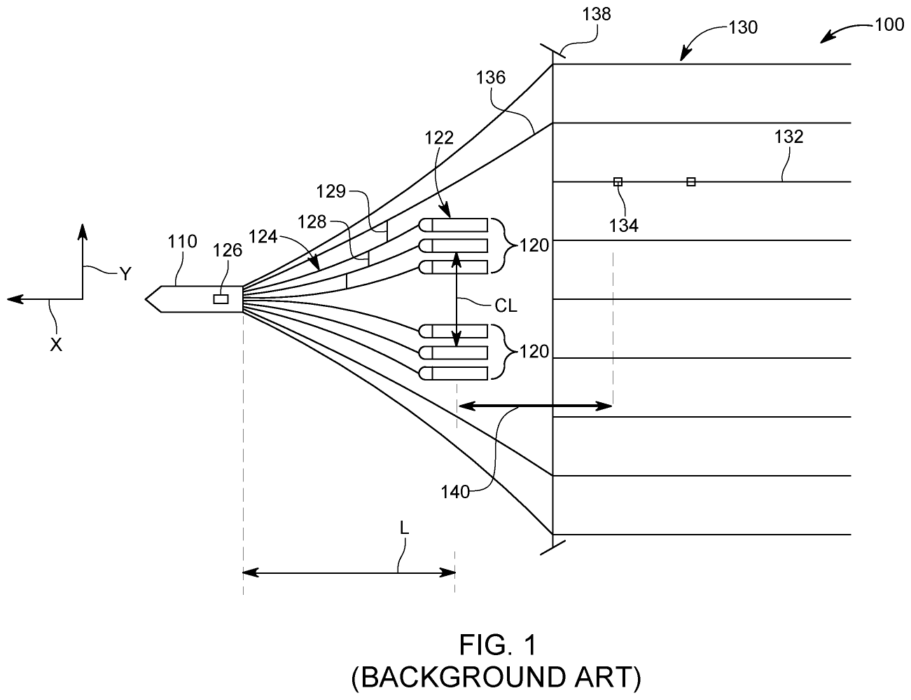

FIG. 2 is a schematic diagram of a marine survey system that has seismic sensors placed in front of the seismic source, on sections attached between the umbilical cables and the seismic sources;

FIG. 3 illustrates a cross-section of the sections that carry the seismic sensors in front of the seismic sources in FIG. 2;

FIG. 4 is a bird-view of the marine survey system of FIG. 2;

FIG. 5 illustrates how the seismic data recorded with the sensors placed ahead of the source fill in the seismic data recorded with ocean bottom nodes;

FIG. 6 illustrates the seismic offset of the umbilical seismic data recorded with the sensors located on the umbilical cable and the streamer seismic data recorded with the sensors located on the streamers;

FIGS. 7A and 7B illustrate the location of the seismic sensors on the umbilical cable or a section to be attached to the umbilical cable;

FIGS. 8A and 8B schematically illustrate the umbilical and streamer seismic data sampling the same bin on the ocean bottom;

FIG. 9 illustrates an umbilical cable that holds the plural seismic sensors; and

FIG. 10 is a flow chart of a method for simultaneously acquiring seismic data with seismic sensors located in front and behind the seismic source along an inline direction.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a marine seismic survey system that uses two sources. However, the embodiments to be discussed next are not limited to two sources, but may be applied to more or less sources (for example, 2D or wide azimuth surveys utilize a single source).

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, there is an umbilical cable that is manufactured to have plural sensors distributed along its length. In one application, the sensors may be located inside the umbilical cable or inside of a separate section that is attached to the umbilical cable, while in another application the sensors are attached to the outside of the umbilical cable. The sensors in the first application may be connected to one or more wires, that extend through the interior of the umbilical cable, to exchange information with a controller located on the vessel. Alternatively, the sensors for the second application are provided with storage means for storing the acquired seismic data and this data may be retrieved when the umbilical cable is brought on the vessel. In a different embodiment, one or more sensor loaded sections may be attached to an existing umbilical cable or a newly manufactured one, so that the sensors are distributed between the vessel and the source, i.e., in front of the source. The terms “front” and “back” are used herein as being relative to the source, along the inline direction. No matter which possible implementation is selected, the seismic sensors placed ahead or in front of the source (note that the seismic sensors of the streamers are placed behind the source relative to the inline direction X) would be able to record seismic data with almost zero offset and negative offset and thus, provide near offset seismic data that is often not recorded by the traditional streamers as discussed above. These embodiments are now discussed in more detail.

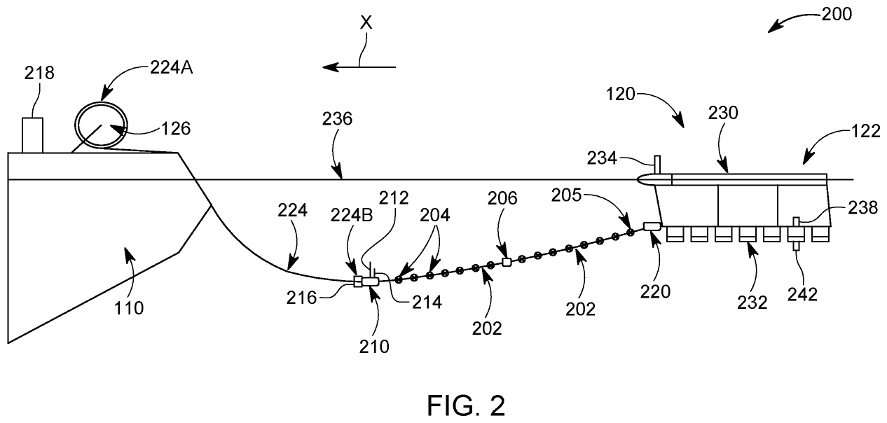

FIG. 2 shows an umbilical-based data acquisition system 200 in which the umbilical cable 224 is attached to one or more sensor loaded sections 202. Each sensor loaded section 202 includes plural sensors 204, for example, one or more hydrophones, geophones, accelerometers, etc. FIG. 2 shows two sections 202, but more sections may be used. In one application, only one section 202 is attached to the umbilical cable. A total length of all the sections 202 attached to the umbilical cable may be between 50 m and 2 km. A sensor 205 (which is part of the sensors 204) that is closest to the source 120 may be located between 1 and 10 m away from the closest gun string 232, which makes possible to record seismic data with effectively zero seismic offset. Two adjacent sections 202 are connected to each other with a section connector 206. The umbilical cable 224 is provided with an umbilical-sensor section connector 210 at its distal end 224B relative to the vessel 110 (note that the proximal end 224A of the umbilical cable 224 is attached to the winch 126 on the vessel 110), to connect to a section 202. The umbilical-sensor section connector 210 may be configured to include an acoustic receiver 212 and an acoustic transmitter 214 and a dampening mechanism 216. The acoustic receiver and transmitter are used to establish relative positions of the plural umbilical cables relative to each other while the dampening mechanism is used to attenuate mechanical waves that are generated by the pulling of the vessel on the umbilical cables, as such waves propagate along the umbilical cables and may negatively impact the accuracy of the recorded seismic data.

In one application, the section connector 206 may be provided with the acoustic receiver 212 and the acoustic transmitter 214. The section connector 206 ensures that the compressed air from the vessel to the source 120 is passing by. Further, the section connector 206 is configured to pass electrical signals from the vessel to the source and also to send seismic data from the sensors 204, if the sensors are located within the section 202, to a controller 218 on the vessel. The umbilical-sensor section connector 210 is also configured, similar to the section 202, to pass the compressed air and electrical signals from the umbilical cable to the section 202 and seismic data from the section 202 to the umbilical cable 224.

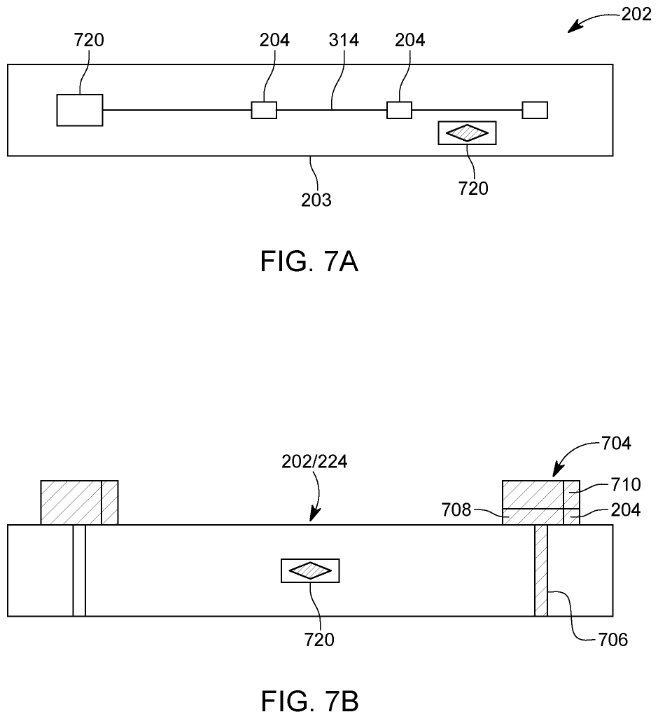

The last section 202 is configured to be attached to a sensor section-source connector 220, which is different from the other connectors 210 and 206, in the sense that this connector is configured to mechanically attach to the source 120. The source 120 is shown in the figure (in fact the figure shows a single gun string or sub-array of the source) as having a float 230 from which plural air guns 232 are suspended. Any number of air guns 232 may be attached to the float. While FIG. 2 shows an air gun source, it is possible to user other type of sources, for example, marine vibrators or sparkles, etc. If this is the case, that the umbilical does not need to have a conduit for the compressed air. Positioning of the gun strings of the source 120 relative to the vessel 110 is achieved via Reference GPS (RGPS) beacons 234 deployed on the gun string float 230, which sit above the water line 236. These beacons 234 provide the position and orientation of the sub-arrays relative to the inline direction X. The gun strings 122 may also have an acoustic receiver and transmitter (similar to 212 and 214) for tying the gun strings into the larger front end acoustic network used to position the streamer cables. Power and data lines for the RGPS can pass through the umbilical cable 224. In addition to the RGPS, the umbilical cables 224 also carry signal and power to depth sensors 238, and near field hydrophones 242, which are located on the gun strings 122. These instruments are used for quality control (QC) and processing steps. The depth sensors 238 are distributed along the umbilical cables 224 as the depth of the cable is needed during the seismic data processing. In one application, the depth sensors 238 are distributed every 50 m along the umbilical cable. One skilled in the art would understand that more or less depth sensors may be used so that the depth sensors are distributed in a range between 10 and 100 m along the umbilical cable. The depth sensors may either be incorporated into a digitization module (which is discussed later), that can be fit between two sections of the umbilical cable, or be incorporated into compass units (discussed later with regard to FIGS. 7A and 7B). The depth sensors on the umbilical cable may be used to determine the depth of each channel, in a similar way as the depth sensors distributed on the streamers are used, and thus, their description is omitted herein.

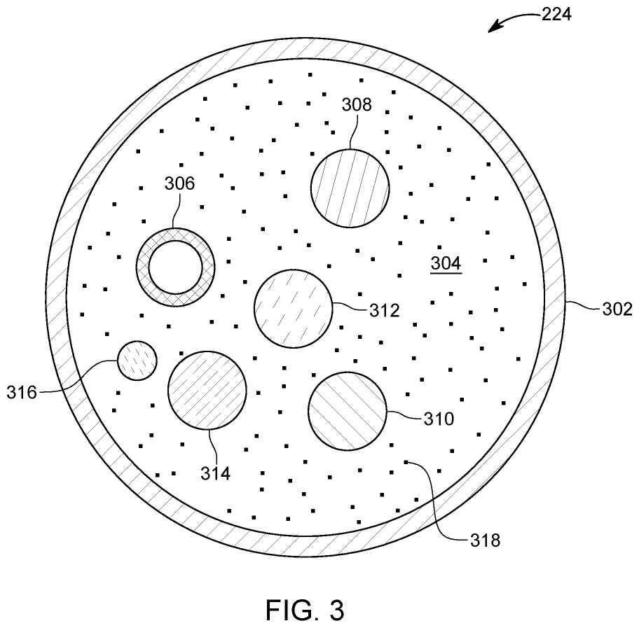

A cross-section of the umbilical cable 224 is now discussed with regard to FIG. 3. The umbilical cable 224 may have an external sheath 302 that protects an interior chamber 304 from salt corrosion or any fluid in which the cable is placed. A compressed air conduit 306 is present inside the chamber 304 and this conduit ensures that compressed air flows from the vessel to the source for activating the air guns. Electrical signals/commands and/or power are transmitted along one or more electrical wires 308, also located inside the chamber 304. These commands are sent to the air guns for actuating their solenoids, to release the compressed air into the water and generate the acoustic signals. Another electrical wire 310 is used for telemetry reasons, i.e., for the various acoustic transmitters and receivers 212/214 discussed above for establishing the location of the gun strings in the water. One or more strength members 312 may also be located within the chamber 304 and these members ensure that the tension that appears due to the friction of the source with the water when the source is towed by the vessel does not damage the other cables and conduits. In other words, all the tension is handled by the strength member 312, which is usually made from steel.

Different from a traditional umbilical cable, the one shown in FIG. 3 also includes (1) one or more electrical wires 314 that form a telemetry network, exclusively dedicated for transmitting the seismic data collected by the sensors 204 to the controller 218 on the vessel, and (2) one or more electrical wires 316 for providing power to the sensors 204. Note that this additional telemetry network 314 and the power supply network 316 may be already physically present in a traditional umbilical cable, but it is not used for powering seismic data collecting sensors and transmitting the seismic data to the vessel. In other words, in one embodiment, the additional telemetry 314 and the power supply network 316 are implemented in existing cables in an umbilical cable, that currently are not used for source related functionalities. A traditional umbilical cable has a telemetry network for providing the reading of the sensors from the source 120 to the vessel, while the umbilical cable 224 is modified to have a second telemetry network 314, functionally separated from the traditional telemetry network 310, for providing the recorded seismic data from the sensors 204 located on the sensor sections 202. The umbilical cable 222 is also modified to have a second power supply network 316 for the seismic sensors 202, which is functionally separated from the power supply wires 308. The remaining of the chamber 304 may be filled with a filler 318, so that all the cables and conduits are fixed in place when the umbilical cable moves in water.

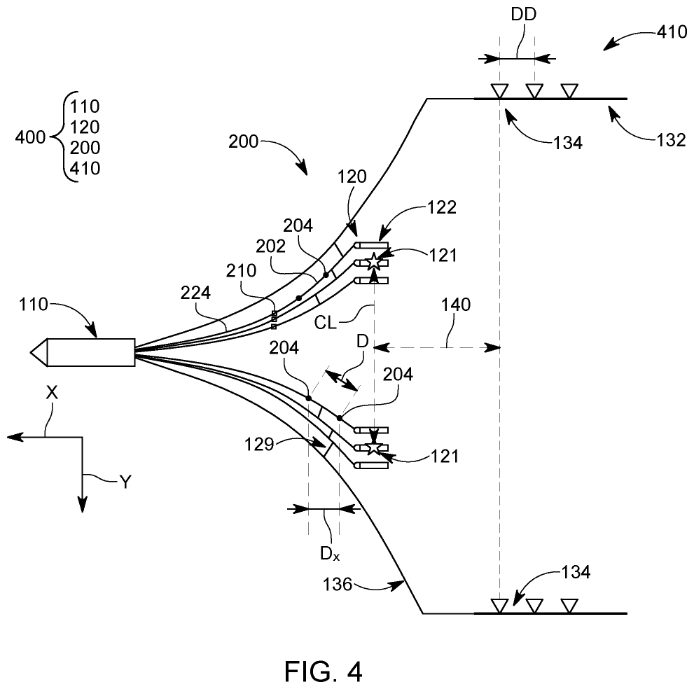

FIG. 4 shows a top view of the umbilical-based data acquisition system 200, the vessel 110, the sources 120, and either a streamer-based acquisition system 410 or an OBN network (not shown), which is discussed later. These four sub-systems form the total data acquisition system 400, i.e., a system that is capable to simultaneously record seismic data from locations in front and behind the source, while the source is not located on top of the streamers if the streamer-based acquisition system 410 is present. Thus, the term “total” is used herein to indicate positive and negative seismic offsets. Those skilled in the art should also understand that the data acquisition system 400 may be used without the streamer-based acquisition system 410 or the OBN network. In other words, the umbilical-based data acquisition system 200 may be used with no streamers or OBN nodes to collect seismic data. For this implementation, the seismic data is collected exclusively with the sensors present in the umbilical-based data acquisition system 200. FIG. 4 shows that an inline distance between a center 121 of the source 120 and a first receiver 134 of the streamer 132 is the seismic offset 140. FIG. 4 also shows the center line CL. Note that FIG. 4 shows only two outer streamers 134 for simplicity, but many more inner streamers may be present between these two outer streamers.

The total data acquisition system 400 is capable to make the seismic offset 140 as small as possible while avoiding tangling the gun strings with the frontend catenary used to tow the streamers used for recording the seismic data. For towed seismic surveys, the seismic offset 140 is typically 100 to 200 m, depending on the size of the seismic spread. The receiver cables are connected to the vessel by leadins 136, which have an armored exterior and internally carry the telemetry and power cables (not shown) needed to operate the sensors 134 within the streamers 132. The front ends of the streamers 134 are connected together by separation ropes (not shown). Floats (not shown) hold up the front of the streamer with a depth rope or chain. The design of the frontend streamer catenary usually results in a seismic offset greater than at least 100 m. The total data acquisition system 400 is capable to record these missing offsets. For towed marine seismic surveys in shallow water environments, the near offsets are particularly desired.

Due to the large inline offset between the back of the vessel 110 and the front of the streamers 132, both the leadins 136 and umbilical cables 224 sag (see FIG. 2) in the water to depths that can exceed 50 m at low water speeds. It is desired that the cables do not come into contact with each other or with any other equipment under the water as any rubbing would results in damage and possible loss of the equipment. The system 400 is not affected by this problem as the source is not floating above the streamers and the leadins 136 do not overlap with the umbilical cables 224.

This is different from the existing seismic acquisition systems, where it is possible to face these kinds of problems. For example, CGG TopSeis system (own by the assignee of the present invention) involves using a source boat on top of the seismic receiver spread. In this way, the source fires on top of the seismic spread and both positive and negative offsets are recorded. The method produced excellent results but has a potential number of drawbacks: (1) expensive as a source vessel is required in addition to the streamer boat; (2) the receiver cables must be towed deep where the source is located to avoid the source becoming tangled in the streamers. This can introduce some frequency notches; (3) additional operational risks arise from loss of propulsion of the source vessel.

Another approach, used by one seismic data acquisition provider, achieved a negative seismic offset during a recent survey by threading the sources through the front end of the streamer spread. This achieves a similar result to the CGG TopSeis system without the expense or risk of having a source boat sailing above the streamer spread, but introduces additional problems: (1) there is a need for very long umbilical cables, especially if it is combined with a large seismic spread, (2) high risk of entangling the streamers with the source arrays, which can lead to a serious tangle and loss of revenue/equipment, (3) the system needs a steerable source and steerable streamers, (4) not all seismic survey providers have this equipment available, (5) limited center of source crossline offset, and (6) significant extended time to deploy and retrieve the sources for maintenance. Weather and or currents will also further delay this process.

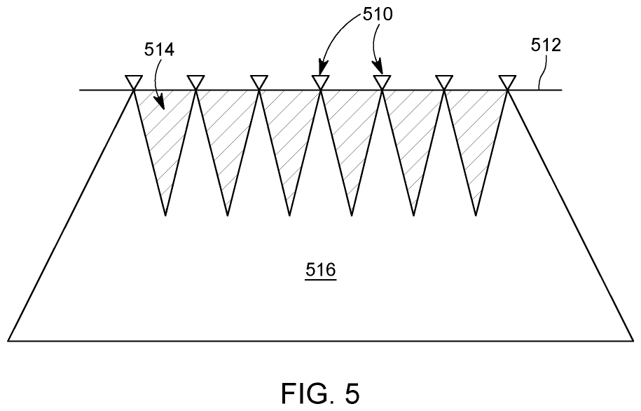

Thus, one skilled in the art would realize the advantages of the system 400 in simultaneously collecting positive and negative seismic offsets in one pass, without the need of complicated seismic equipment, and sophisticated methods, and also the advantage of the system 200 in collecting negative seismic offsets, which may be used for augmenting the OBN collected seismic data. In other words, the seismic data collected by the system 200 is useful for complementing OBN data as this is achieved with a source vessel, i.e., no dedicated streamer vessel is required. In this regard, although zero and near offset data is recorded for OBN, complementary streamer data is of help to fill in the missing shallow illumination as shown in FIG. 5. The figure shows plural OBN receivers 510 deployed on the ocean bottom 512. Areas 514 are the missing areas of data due to the spatial distribution of the receivers on the ocean floor while areas 516 correspond to those where there is seismic data recorded by the OBN receivers 510. Although the missing data can be filled using the OBS down-going wavefield, this not always possible in very shallow water environments. In this case, the sensors 204 on the sensor loaded sections 202 attached to the umbilical cable 224 are able to supply the needed near offset seismic data.

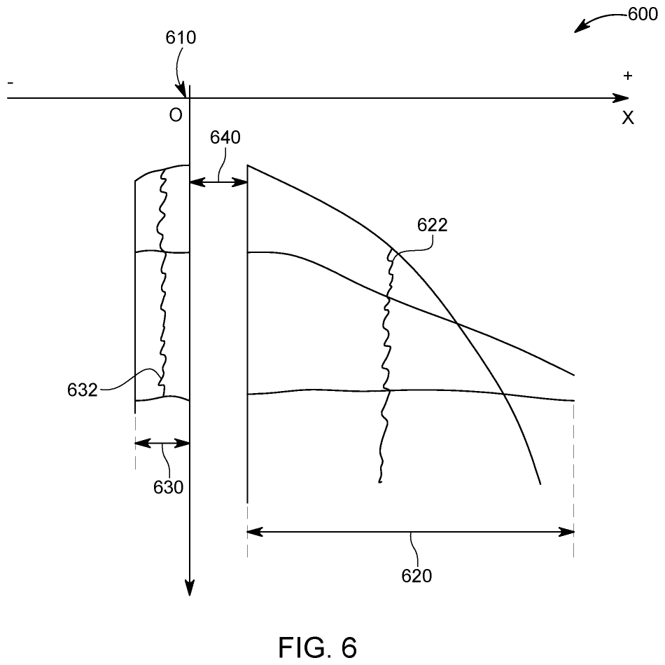

FIG. 6 schematically illustrates the position 610 of the seismic source 120 during a seismic survey performed with the system 400, the streamer seismic data 620 that is possible to be recorded with the streamer-based acquisition system 410, the umbilical seismic data 630 (which can extend up to 2 km of near offsets) that is possible to be recorded with the umbilical-based acquisition system 200, and the still missing near offset seismic data 640, which is so due to the configuration of the streamer-based acquisition system 410. Axis X in the figure indicates the positive and negative seismic offset (and coincides with the inline direction), with the origin O of the axis indicating the position of the source. Note that the traces 622 and 632 shown in FIG. 6 (only two traces are shown for simplicity) correspond to a synthetic shot gather 600 that would be acquired with the system 400.

It is observed from this figure that the umbilical seismic data 630 has zero seismic offset and very small seismic offset, e.g., not more than 1 km, depending on the length of the umbilical cable and/or section 202. In other words, the sensor loaded section 202 is capable of recording seismic data having a seismic offset between 0 m and 1 km. Note that the streamer seismic data 620 is missing the zero seismic offset and the near zero seismic offset (seismic data 640) because of the positions of the streamers away from the source. This means that the streamer seismic data 620 does not have seismic data with a seismic offset less than 100 or 200 m, while the umbilical seismic data 630 can effectively achieve zero seismic offset data.

The location of the sensors 204 along the sections 202 might vary depending on the needs of the survey. In one application, digital sensors are mounted in or on the sections 202, and these sensors may include one or more of hydrophones, geophones, and multi-component accelerometers. The sensors may be placed in one embodiment at intervals, down the section, with an average spacing of 1.5 m. In one embodiment, the sensors are placed along the sections 202 so that an inline distance (i.e., distance on the X axis) between adjacent sensors is equal to the inline distance of the sensors 134 on the streamer 132. In other words, the effective distance D between two adjacent sensors 204 along a section 202 (see FIG. 4) is selected so that its inline axis X projection Dx is equal to the distance DD between two adjacent sensors 134 on the streamer 132. The intervals between the sensors 204 may be pseudo-randomized to act as a spatial group filter. Groups of sensors 204 may be summed together to filter out noise to form a single channel every 12.5 m or lower, on average. The sensors 202 may be configured to have an inbuilt low-cut analogue filter. Digital high-cut filters would be applied during processing and based primarily on the Nyquist sampling frequency. The digitized data from the sensors 204 is transmitted through the section 202 (more specifically, telemetry network 314 in FIG. 3) to the recording equipment (e.g., controller 218) on the vessel 110. This may be achieved by a digitization module, which is either built into the section 204, similar to the structure of a streamer, or fitted externally in the form of an independent module.

FIG. 7A shows one possible implementation of the section 202, where all the sensors 204 are fitted inside the skin 203 of the section, while FIG. 7B shows another possible implementation in which each sensor 204 is located within a corresponding module 704, which is externally attached to the section 202 or directly to the traditional umbilical cable 224 with, for example, one or more bands 706. The module 704 may also include a storage device 708, e.g., a memory, for storing the recorded seismic data, and a battery 710 for powering the sensor 204. Different from the embodiment shown in FIG. 7B, the sensor 204 in FIG. 7A is connected by an internal cable 314 to a processing module 720, which collects the seismic data for plural sensors and generates a single data point that is sent to the vessel. For the embodiment of FIG. 7B, the seismic data for each sensor is collected in the local memory 708, and when the umbilical cable is brought onto the vessel, each sensor is removed from section 202 and its data is downloaded into the controller 218. Note that details about recording the data, transferring the data from the sensors to the vessel and recharging the modules 704 for reuse are known in the art of offshore seismic acquisition and thus, these details are omitted herein, but they are understood to be applicable to these embodiments and incorporated herein by reference.

FIGS. 7A and 7B further show the presence of at least one compass 720 for determining a location of the section 202 or umbilical cable 224 in the XY plane (see FIG. 4). This location of the section 202 and/or umbilical cable 224 is necessary for knowing the exact location of each sensor 204 along the inline direction X as the seismic data recorded by the streamers 132 is recorded along the inline direction. In this regard, real-time positioning of the umbilical cable and sections 202 is more of a challenge than for the conventional streamers because the acoustic networks are unlikely to perform well in the wake of the vessel. However, the start and end positions where the umbilical cable leaves the back of the vessel and section 202 then joins the gun string 122 is known with high precision as both the vessel and the source 120 have their own GPS equipment. In this embodiment, by combining the data collected from an acoustic network formed by the receivers and transmitters 212 and 214, compasses 720, depth sensors 238, and dead reckoning, it would be possible to calculate the positions for the individual sensors along the umbilical cable and/or the sections 202. Acoustic pods, compasses and depth sensors would either be built into the umbilical cable or fixed externally to it in the modules 704.

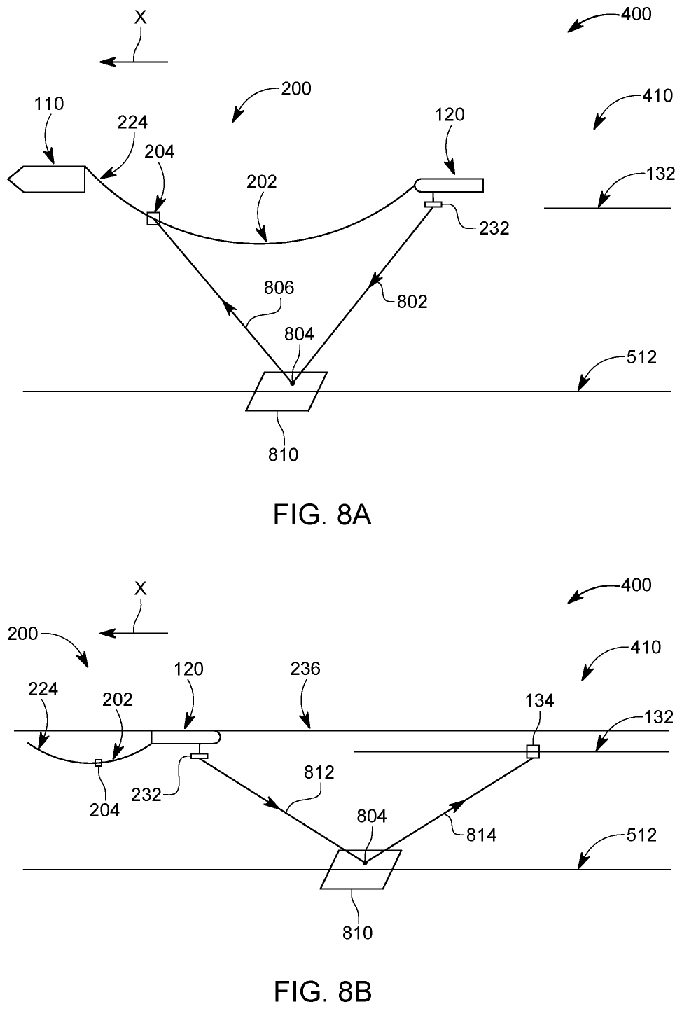

In terms of the characteristics of the seismic data acquired by the novel system 400, as illustrated in FIGS. 8A and 8B, a bin 810 on the ocean bottom 512 or at any interface between two layers in the subsurface, is related to various seismic data. FIG. 8A shows a seismic wave 802, which is generated by the air gun 232 (only one air gun is shown for simplicity), being reflected at a reflection point 804 in the bin 810, and the reflected wave 806 is being recorded by a sensor 204 on the section 202. Note that there are many bins for a given seismic survey, but only one is shown and discussed herein for simplicity as the following arguments apply to all the bins. After the vessel 110 moves along the inline direction X, as shown in FIG. 8B, another seismic wave 812 generated by the air gun 232 or another air gun of the source 120, strikes the same bin 810, and the reflected seismic wave 814 is now recorded by a sensor 134 of the streamer 132. Thus, the system 400 generates umbilical-based seismic data 630 recorded by the section 202 and streamer-based seismic data 620 that is recorded by the streamer 132 that survey the same bin 810, but with different seismic offsets (one positive and one negative in this arrangement). In other words, the combination of the sensor loaded section 202 provided in front of the source 120 and the streamer 132 provided behind the source 120 generates seismic data 620 and 630 that covers the same bin, with short and long seismic offsets. This data is achieved in a single pass over the bin 810 and the two kinds of data can be combined for generating a single image of the subsurface. The same is true if the system 400 is used with OBN 510 instead of the streamers 132. Thus, FIGS. 8A and 8B are intended to apply to both situations.

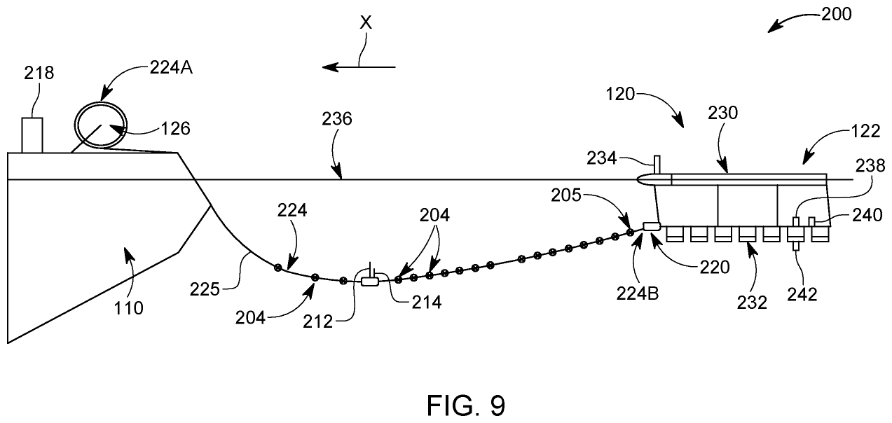

In another embodiment, as illustrated in FIG. 9, the plural sensors 204 are directly located in or on the body 225 of the umbilical cable 224 and thus, there are no sections 202 that connect the umbilical cable to the source 120. In this embodiment, the umbilical cable 224 is connected with its proximal end directly to the vessel 110 and with its distal end directly to the source 120. The connector 220 is in this case an umbilical-source connector. The distribution of the sensors 204 is similar to that shown in FIGS. 2 and 4 and discussed above. In other words, the sensors 204 may be distributed inside the body 225 of the umbilical cable, as shown in FIG. 7A, or can be attached as a module, as shown in FIG. 7B, to an exterior of the body 225. The sensors are distributed at similar distances as the sensors 134 on the streamers 132. The closest sensor 205 to the source may be located at a distance of 10 m or less. A length of the umbilical cable for this embodiment is between 50 m and 2 km. Plural acoustic receivers and transmitters 212 and 214 may be located on the umbilical cable for determining the positions of the cable. In one embodiment, it is possible to combine the embodiments shown in FIGS. 2 and 9, i.e., to have seismic sensors distributed not only on the sensor loaded section 202, but also on the umbilical cable 224. In this regard, note that the umbilical cable 224 in the embodiment illustrated in FIG. 2 does not have seismic sensors.

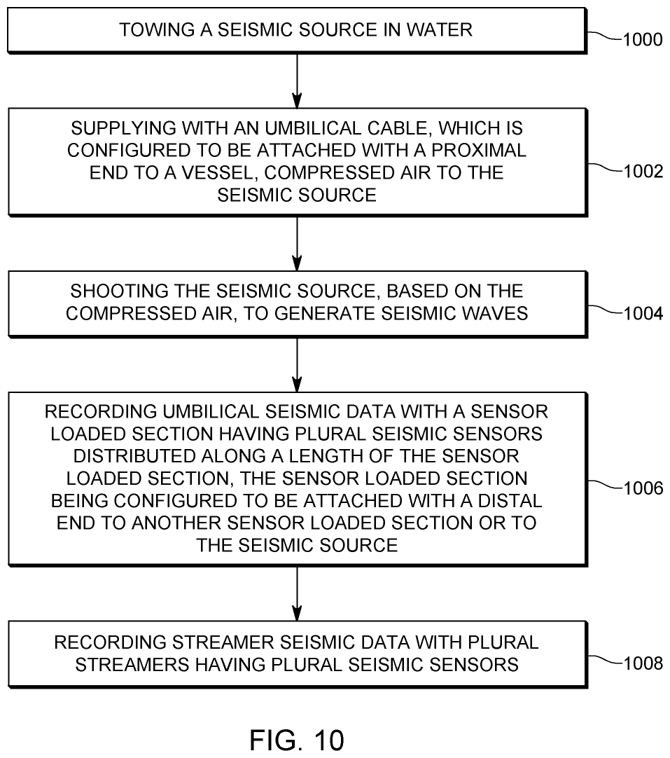

A method for simultaneously collecting seismic data with positive and negative seismic offsets is now discussed with regard to FIG. 10. The method includes a step 1000 of towing a seismic source in water, a step 1002 of supplying with an umbilical cable, which is configured to be attached with a proximal end to a vessel, compressed air to the seismic source, a step 1004 of shooting the seismic source, based on the compressed air, to generate seismic waves, a step 1006 of recording umbilical seismic data with a sensor loaded section having plural seismic sensors distributed along a length of the sensor loaded section, the sensor loaded section being configured to be attached with a distal end to another sensor loaded section or to the seismic source, and a step 1008 of recording streamer seismic data with plural streamers having plural seismic sensors. The sensor loaded section is configured to pass the compressed air to the seismic source. The umbilical seismic data and the streamer seismic data are simultaneously recorded in this embodiment, the umbilical seismic data has a negative seismic offset, and the streamer seismic data has a positive seismic offset. However, the umbilical-based marine acquisition system 200 can be used without a streamer spread, for example, if the umbilical cables hosting the system 200 are used with a vessel that tows only sources and no streamers. In yet another application, the umbilical-based marine acquisition system 200 can be used with an OBN system so that the umbilical seismic data has a negative offset while the OBN seismic data may have both positive and negative offsets.

The system discussed herein might have a fold coverage issue for streamers with a relatively big cable spread, as the zero/near offset data from the umbilical cable will have narrow cross-line coverage with each sail line passing, especially if conventional narrow towed dual-source or triple-source are used. This is less a problem for OBN case, though for a dual-source, as an example, it is expected that the umbilical traces will cover a quarter of the sub-surface.

The disclosed embodiments provide a seismic data acquisition system that simultaneously acquires seismic data in front and behind the source. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. An umbilical-based marine acquisition system comprising:
an umbilical cable configured to be attached with a proximal end to a vessel and to provide compressed air to a seismic source;
a sensor loaded section having plural seismic sensors distributed along a length of the sensor loaded section, the sensor loaded section being configured to be attached with a distal end to another sensor loaded section or to the seismic source; and
an umbilical-sensor section connection configured to connect a distal end of the umbilical cable to a proximal end of the sensor loaded section,
wherein the umbilical-sensor section connection and the sensor loaded section are configured to transmit seismic data acquired by the plural seismic sensors to the vessel.

2. The umbilical-based marine acquisition system of claim 1, wherein the plural seismic sensors are located in front of the seismic source to record the seismic data with a seismic offset smaller than 100 m.

3. The umbilical-based marine acquisition system of claim 1, wherein at least one sensor of the plural sensors is located less than 10 m away from an air gun of the seismic source.

4. The umbilical-based marine acquisition system of claim 1, wherein none of the plural sensors is located on the seismic source.

5. The umbilical-based marine acquisition system of claim 1, wherein the plural sensors include at least one of hydrophones and accelerometers.

6. The umbilical-based marine acquisition system of claim 1, further comprising:
additional sensor loaded sections, each having the plural seismic sensors distributed along a length of the additional sensor loaded sections,
wherein the additional sensor loaded sections are functionally connected in series to the sensor loaded section.

7. The umbilical-based marine acquisition system of claim 1, wherein the umbilical-sensor section connection is configured to pass the compressed air and has an acoustic receiver and an acoustic transmitter.

8. The umbilical-based marine acquisition system of claim 1, wherein the sensor loaded section comprises a telemetry network exclusively dedicated to the plural sensors.

9. The umbilical-based marine acquisition system of claim 1, wherein the plural sensors are located so that (1) seismic data collected with the plural sensors and (2) seismic data collected with streamers towed by the vessel or ocean bottom nodes correspond to a same bin on the ocean bottom.

10. The umbilical-based marine acquisition system of claim 1, wherein the plural sensors are separated, on an inline axis X, by a same distance as sensors on a streamer towed by the vessel.

11. An umbilical cable comprising:
a body configured to be attached with a proximal end to a vessel and with a distal end to a seismic source; and
plural seismic sensors distributed along a length of the body,
wherein the body is configured to transmit seismic data acquired by the plural seismic sensors to the vessel.

12. The umbilical cable of claim 11, wherein the plural seismic sensors are located next to the seismic source to record seismic data with a seismic offset smaller than 100 m.

13. The umbilical cable of claim 11, wherein at least one sensor of the plural sensors is located less than 10 m away from an air gun of the seismic source.

14. A total data acquisition system comprising:
a seismic source configured to be towed in water and to generate seismic waves with plural air guns;
an umbilical cable configured to be attached with a proximal end to a vessel and to provide compressed air to the seismic source;
a sensor loaded section having plural seismic sensors distributed along a length of the sensor loaded section, the sensor loaded section being configured to be attached with a distal end to another sensor loaded section or to the seismic source;
an umbilical-sensor section connection configured to connect a distal end of the umbilical cable to a proximal end of the sensor loaded section; and
plural streamers having plural seismic sensors,
wherein the umbilical-sensor section connection and the sensor loaded section are configured to pass the compressed air to the seismic source.

15. The total data acquisition system of claim 14, wherein the plural seismic sensors of the sensor loaded section record first seismic data with a negative seismic offset, and the plural seismic sensors of the plural streamers record second seismic data with a positive seismic offset.

16. The total data acquisition system of claim 14, wherein the plural seismic sensors of the sensor loaded section are located next to the seismic source to record seismic data with a seismic offset smaller than 100 m.

17. The total data acquisition system of claim 14, wherein at least one sensor of the plural sensors of the sensor loaded section is located less than 10 m away from an air gun of the seismic source.

18. The total data acquisition system of claim 14, wherein none of the plural sensors is located on the seismic source.

19. The total data acquisition system of claim 14, wherein the plural sensors of the sensor loaded section are located so that (1) seismic data collected with the plural sensors and (2) seismic data collected with the streamers towed by the vessel or with ocean bottom nodes correspond to a same bin on the ocean bottom.

20. A method for simultaneously collecting seismic data with positive and negative seismic offsets, the method comprising:
towing a seismic source in water;
supplying with an umbilical cable, which is configured to be attached with a proximal end to a vessel, compressed air to the seismic source;
firing the seismic source, based on the compressed air, to generate seismic waves;
recording umbilical seismic data with a sensor loaded section having plural seismic sensors distributed along a length of the sensor loaded section, the sensor loaded section being configured to be attached with a distal end to another sensor loaded section or to the seismic source; and
recording streamer seismic data with plural streamers having plural seismic sensors,
wherein the sensor loaded section is configured to pass the compressed air to the seismic source, and
wherein the umbilical seismic data and the streamer seismic data are simultaneously recorded, the umbilical seismic data has a negative seismic offset, and the streamer seismic data has a positive seismic offset.
